(19) United States
(12) Patent Application Publication
(10) Pub. No.: US 2008/0098738 A1
(43) Pub. Date: May 1, 2008

(54) Method for improved efficiency for high hydrogen

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 11/977,803

(22) Filed: Oct. 25, 2007

Related U.S. Application Data
(60) Provisional application No. 60/854,895, filed on Oct. 27, 2006.

(51) Int. Cl. F02C 1/00

(52) U.S. Cl. 60/746

(57) ABSTRACT

A method for operating a gas turbine is provided wherein a supply of fuel is passed to a gas turbine combustor, and a supply of nitrogen and sufficient air to provide at least sufficient compressed air to the gas turbine for fuel combustion is passed to a compressor. A sufficient portion of the compressor discharge flow is passed to a combustor for fuel rich combustion of the fuel flow to the combustor and the fuel is combusted to produce hot combustion gases that are, in turn, passed to a turbine.

### CROSS-REFERENCE TO RELATED APPLICATION

This application claims the benefit of U.S. Provisional Application No. 60/854,895 filed Oct. 27, 2006.

### BACKGROUND OF THE INVENTION

1. Field of the Invention

The present invention relates to a method of achieving ultra-low NOx without sacrificing thermal efficiency for hydrogen fueled gas turbines. In particular, the present invention comprises a method for minimizing the need to extract compressor discharge air to limit mass flow through the power turbine, as is typically required in low NOx systems to maintain turbine rotor stress levels within acceptable limits. Systems of the present invention allow increased turbine inlet temperature, further improving system efficiency.

2. Brief Description of the Related Art

With energy usage directly related to economic growth, there has been a steady increase in the need for increased energy supplies. In the U.S., coal is abundant and low in cost. Unfortunately, conventional coal-fired steam plants, which are a major source of electrical power, are inefficient and pollute the air. Thus, there is a pressing need for cleaner, more efficient coal-fired power plants.

Accordingly, Integrated Gasification Combined-Cycle (IGCC) systems have been developed which can achieve significantly improved efficiencies in comparison to conventional steam plants. In such a system, syngas (a mixture comprising hydrogen and carbon monoxide) is produced by partial oxidation of coal or other carbonaceous fuel. This allows cleanup of sulfur and other impurities before combustion. Further, the carbon monoxide can be reacted with steam using the water gas shift reaction to form carbon dioxide and hydrogen. Carbon dioxide may then be recovered using conventional technologies known in the art. This allows pre-combustion recovery of carbon dioxide for sequestration and produces a high hydrogen content fuel. Gas turbines may also be powered by hydrogen produced in heavy oil recovery for upgrading the oil and in various chemical processes as a by-product.

Regardless of the source or purity, hydrogen poses an emission problem on combustion. Even without removal of carbon from syngas, the hydrogen content of the gas is typically too high to allow use of conventional dry low NOx premixed combustion for NOx control. Hydrogen ignition delay is short and the flame speed is high. Therefore, diffusion flame combustion is used with diluent added to the gas to minimize NOx by lowering the adiabatic flame temperature. Even so, exhaust gas cleanup may still be required. Thus, such systems cannot achieve present standards for NOx emissions without removal of NOx from the exhaust gas and the consequent efficiency loss. Improved combustion systems are needed.

There are further efficiency loss issues. If nitrogen is used to dilute the fuel gas, there is an energy penalty for nitrogen compression to the pressure needed for mixing with the fuel gas. Typically, avoiding excessive loads on the turbine rotor requires operation at a reduced turbine temperature and/or bleed of compressed air from the turbine compressor.

It is therefore an object of the present to provide a method for achieving ultra low NOx emissions in combustion of high purity hydrogen and syngas in gas turbines. It also an object of the present invention to provide a method for improving the thermal efficiency of power systems wherein the fuel comprises hydrogen.

### DESCRIPTION OF THE INVENTION

The present invention is a method for achieving ultra low NOx emissions in combustion of high purity hydrogen and syngas in gas turbines. It also provides a method for improving the thermal efficiency of power systems wherein the fuel comprises hydrogen. The term “hydrogen” as used herein includes both hydrogen and syngas. The present invention uses non-premixed combustion of hydrogen at fuel-air ratios slightly greater than stoichiometric. It has now been found that by reducing the oxygen content of the inlet air to the amount needed to achieve the desired combustor temperature, even a modest excess of fuel provides significant reduction in NOx. Although conceived for fuels where lean premixed combustion poses problems, conventional fuels may be used. Levels below two ppm are readily achievable using a conventional diffusion flame combustor. No diluent need be added to the fuel and thus there is no increase in mass flow.

In sum, a supply of hydrogen is passed to a gas turbine combustor. A supply of nitrogen is made available. Sufficient air to provide at least sufficient compressed air to the gas turbine for fuel combustion is passed to a compressor along with the nitrogen. A sufficient portion of the compressor discharge flow is passed to a combustor for fuel rich combustion of the hydrogen fuel flow to the combustor. The fuel is combusted to produce hot combustion gases that are, in turn, passed to a turbine. Additional air may be added downstream for burn-out of residual fuel values. Sufficient residual fuel may be left to provide the exhaust gas heating of the turbine exhaust required for combined cycle efficiency. A portion of the compressor discharge may be used for turbine cooling. In order to achieve improved thermal efficiency, the turbine may be operated at a higher turbine inlet temperature than would be used with nitrogen diluted syngas fuel or with steam diluted syngas fuel.

In the present invention, high hydrogen fuels may be used, even seventy percent or higher. In IGCC systems with CO2 removal, the de-carbonated hydrogen fuel may be used as-is. Low NOx is achieved as illustrated below.

The following example assumes use of pure hydrogen.

| | | |
|---|---|---|
| Turbine:- | press ratio - 17/1 | Comb. Temp. - 1737 Kelvin |
| | Air Inlet - 700 Kelvin | Phi 1.04 |

Air composition - 0.21 moles O2 per 2.4 moles N2
Equilibrium NOx - 1.4 ppm

In contrast to the above, operating at stoichiometric (Phi=1.0) yields an equilibrium NOx of 55 ppm. At a lean Phi of 0.99, NOx is 200 ppm.

The nitrogen can be available at a temperature much lower than ambient air temperature, and compressor inlet temperature can be maintained at a value for maximum efficiency and power even at high ambient air temperatures. This improves system efficiency. If no nitrogen or steam diluent is added to the fuel, no reduction in turbine inlet temperature is needed to compensate for the resulting increased mass flow through the gas turbine, and there is no need to bleed off compressor discharge air to reduce turbine mass flow combustion. In the present invention, cooled turbine exhaust gases may be used substitute for all or a portion of the nitrogen diluent stream. Although the above example is for only four percent excess fuel, it is typically advantageous to use greater excess, for example thirty percent (Phi of 1.3) to allow rich operation at part load.

### BRIEF DESCRIPTION OF THE DRAWINGS

FIG. 1 depicts a typical combined cycle system of the present invention.

### DETAILED DESCRIPTION OF THE INVENTION

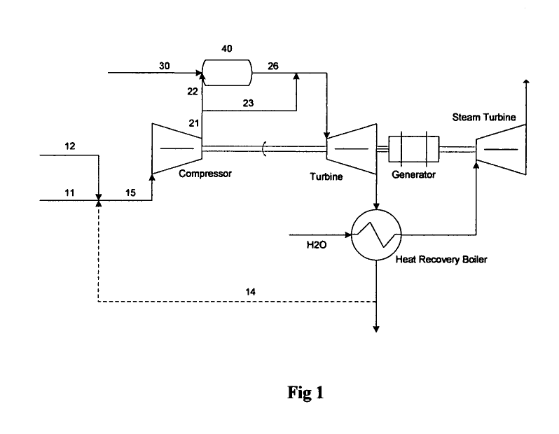

A typical combined cycle system of the present invention is depicted schematically in FIG. 1. As shown, turbine air flow 11 is joined by nitrogen feed 12 and optionally exhaust gas recycle stream 14 forming mixed air stream 15. Compressor discharge 21 is split into combustor primary air 22 and after burner air stream 23. Fuel stream 30 is fed to combustor 40 for rich non-premixed combustion with primary air 22. Air stream 23 is in sufficient quantity to combust all fuel values in primary combustion product stream 26.

Although the invention has been described in detail with respect to passing a nitrogen feed into a turbine air flow, it will be apparent that the invention is capable of modifications and variations, apparent to those skilled in the art, without departing from the spirit and scope of the invention.

1. A method of operating a gas turbine comprising:
a) passing a supply of fuel to a gas turbine combustor;
b) obtaining a supply of nitrogen;
c) passing the nitrogen to a gas turbine compressor along with sufficient air to provide at least sufficient compressed air to the gas turbine for fuel combustion;
d) compressing the nitrogen and the air to provide a compressor discharge flow;
e) passing a sufficient portion of the compressor discharge flow to a combustor for fuel rich combustion of the fuel flow to the combustor;
f) combusting the fuel to produce hot combustion gases; and
g) passing the combustion gases to a turbine.

2. The method of claim 1 wherein additional air is mixed downstream with the hot combustion gases for burnout of the remaining fuel values.

3. The method of claim 2 wherein a portion of the compressor discharge is used for turbine cooling.

4. The method of claim 1 wherein the turbine is operated at a higher turbine inlet temperature than would be used with nitrogen diluted syngas fuel.

5. The method of claim 1 wherein the turbine is operated at a higher turbine inlet temperature than would be used with steam diluted syngas fuel.

6. The method of claim 1 wherein the fuel is burned in a non-premixed or diffusion flame.

7. A method of operating a hydrocarbon fueled gas turbine comprising:
a) passing a supply of fuel to a gas turbine combustor;
b) obtaining a supply of low pressure nitrogen;
c) passing the nitrogen to a gas turbine compressor along with sufficient air to provide at least sufficient compressed air to the gas turbine for fuel combustion;
d) compressing the nitrogen and the air to provide a compressor discharge flow;
e) passing a sufficient portion of the compressor discharge flow to a combustor for rich combustion of the fuel flow to the combustor;
f) combusting the fuel to produce hot combustion gases; and
g) passing the combustion gases to a turbine.

8. The method of claim 1 wherein air is added to a turbine discharge flow to burn out remaining fuel and raise the exhaust temperature for heat recovery.

9. The method of claim 8 wherein the heated turbine discharge flow is fed to a heat recovery boiler.
